(19) United States
(12) Patent Application Publication
(10) Pub. No.: US 2007/0291901 A1
(43) Pub. Date: Dec. 20, 2007

(54) X-RAY TUBE WINDOW BONDING WITH SMOOTH BONDING SURFACE

(75) Inventor: Don Lee Warburton, West Jordan, UT (US)

Correspondence Address: VARIAN MEDICAL SYSTEMS TECHNOLOGIES, INC.;C/O WORKMAN NYDEGGER, 60 E. SOUTH TEMPLE, SUITE 1000, SALT LAKE CITY, UT, 84111, US

(73) Assignee: VARIAN MEDICAL SYSTEMS TECHNOLOGIES, INC., Palo Alto, CA (US)

(21) Appl. No.: 11/424,420

(22) Filed: Jun. 15, 2006

(51) Int. Cl. H01J 35/18; H01J 5/18

(52) U.S. Cl. 378/140

(57) ABSTRACT

This disclosure is concerned with x-ray tube window bonding using a smooth bonding surface. In one example, an x-ray tube window assembly in the evacuated housing of an x-ray tube includes a window frame with a support flange surrounding an aperture, a window constructed to cover the aperture and overlap an area of the support flange of the window frame; and a bond layer connecting the window to the area of the support flange overlapped by the window. The surface of the bond layer in contact with the window is smooth. The bond layer substantially covers the area of the support flange of the window frame overlapped by the window.

### BACKGROUND OF THE INVENTION

1. The Field of the Invention

The present invention relates generally to x-ray tubes. More specifically, exemplary embodiments of the present invention relate to an improved method and apparatus for improved bonding of an x-ray tube window to an x-ray tube window frame.

2. Related Technology

X-ray tubes typically utilize an x-ray transmissive window formed in the housing of the x-ray tube that permits x-rays produced within the tube to be emitted from the housing and into a subject. The window is typically set within a window frame, and is located in the side or in the end of the x-ray tube. The window is typically a disk-shaped plate comprised of beryllium or similar materials that are x-ray transmissive. The window separates the vacuum of the evacuated enclosure of the x-ray tube from the normal atmospheric pressure found outside the tube, and yet enables x-rays generated within the x-ray tube to exit the x-ray tube and strike an intended target.

Although window thickness will vary depending on the particular x-ray tube application, windows are typically very thin, often measuring 0.010 inches or less. In particular, a window with a reduced thickness is generally desired so as to minimize the amount of x-rays that are absorbed by the window material during x-ray tube operation.

While a thinner window is desirable, a thin window is typically subjected to deforming stresses during the manufacturing process of the x-ray tube. Such deforming stresses are non-uniformly distributed over the surface of the window and can produce cracking in the window and leaks between the window and the window frame. This can cause the x-ray tube housing to lose its vacuum, and render the x-ray device inoperable.

One portion of the window which is frequently deformed is the portion of the window that is bonded to the window frame. The window is typically diffusion bonded to a support flange of the window frame. The support flange typically extends substantially parallel to the plane in which window frame is situated. The support flange is sometimes configured to extend at an angle with respect to the window frame so as to project inwardly toward an interior of the evacuated housing.

Diffusion bonding can be accomplished by utilizing a bond layer between the window and the support flange of the window frame. The area of the support flange covered or overlapped by the window is known as the bonding area. The bond layer is typically applied in a limited fashion resulting in the bond layer covering less than the entire bonding area of the window. The bond layer is also typically applied in an uneven fashion which results in a relatively rough surface finish on the surface of the bond layer in contact with the window. When the thin beryllium window is diffusion bonded to the support flange, the window tends to deform around the rough contours of the limited and rough bond layer. This area of deformation can produce cracking in the window and leaks between the window and the window frame.

Similarly, diffusion bonding can be accomplished without utilizing a bond layer between the window and the support flange of the window frame. This form of diffusion bonding results in the attachment of the window directly to the surface of the support flange. The typical surface finish of the support flange is relatively rough. When the thin beryllium window is diffusion bonded to the support flange, the window tends to deform around the rough contours of the surface of the support flange. This area of deformation can likewise produce cracking in the window and leaks between the window and the window frame.

The deformation of the window worsens after the x-ray tube is processed in high temperature environments during tube manufacture. One example of such high temperature processing is air baking. This process involves heating the x-ray tube, with the window and windrow frame attached to the tube housing, to approximately 450 to 475 degrees Celsius for a given amount of time. This imposes a relatively high level of thermally-induced stresses in the window area and, when combined with the stresses caused by the diffusion bonding, further results in the surface of the window being stressed and deformed around the rough contours of the limited and uneven bond layer or the rough surface area of the support flange in the case where no bond layer is present. Again, these conditions can result in cracking of the window and consequent loss of vacuum from the x-ray tube housing, and thereby limit the operational life of the x-ray device.

One approach used to overcome this problem is to increase the thickness of the window. Thicker windows are inherently stronger and less susceptible to stress and the resultant cracks. However, a thicker window is less transmissive to x-rays, especially those of lower energy. This can be especially problematic in low power x-ray tubes.

Consequently, it would be desirable to provide an x-ray tube window that suffers less from the effects of deforming stress, and yet maintains sufficient transmissivity to x-rays.

### BRIEF SUMMARY OF SOME EXEMPLARY EMBODIMENTS OF THE INVENTION

In view of the foregoing, embodiments of the invention are generally concerned with an improved method and apparatus for bonding an x-ray tube window to an x-ray tube window frame. Further, embodiments of the invention are directed to reducing mechanical and thermal stresses on a window used in an x-ray tube. Moreover, the window is designed to allow x-rays generated within the x-ray tube to exit the x-ray tube without undue attenuation of the x-rays by the window.

In one exemplary embodiment of the invention, a window assembly for an evacuated housing of an x-ray tube includes a window frame comprising a support flange that surrounds an aperture, a window constructed to cover the aperture and overlap an area of the support flange of the window frame, and a bond layer connecting the window to the area of the support flange overlapped by the window. In this exemplary embodiment, the surface of the bond layer in contact with the window is smooth and the bond layer substantially covers the area of the support flange overlapped by the window.

In another exemplary embodiment of the invention, a method of attaching a window to a support flange of a window frame in an evacuated housing of an x-ray tube includes constructing the window to overlap the support flange of the window frame, applying a bond layer to substantially the entire area of the support flange that will be overlapped by the window, smoothing the surface of the bond layer that will be in contact with the window, placing the window on the bond layer, and diffusion bonding the window to the bond layer and diffusion bonding the bond layer to the support flange.

In yet another exemplary embodiment of the invention, a window assembly for an evacuated housing of an x-ray tube includes a window frame comprising a support flange that surrounds an aperture. The support flange has a smooth surface area with a surface finish value Ra of about 64 or less. The window assembly also includes a window constructed to cover the aperture and overlap the smooth surface area of the support flange. The portion of the window overlapping the smooth surface area of the support flange is connected to the smooth surface area of the support flange forming a vacuum-tight seal between the window and the support flange.

These and other aspects of embodiments of the invention will become more fully apparent from the following description and appended claims.

### BRIEF DESCRIPTION OF THE DRAWINGS

In order that the manner in which the above recited and other useful aspects and objects of the invention are obtained, a more particular description of the invention briefly described above will be given by making reference to a specific embodiment that is illustrated in the appended drawings. These drawings depict only one embodiment of the invention and are not to be considered limiting of its scope.

FIG. 1 illustrates a simplified cross-sectional illustration of an exemplary x-ray tube showing a window positioned in the side of the x-ray tube housing;

FIG. 2 is a cross-sectional illustration of a first exemplary embodiment of a bond layer;

FIG. 3 is a cross-sectional illustration of a second exemplary embodiment of a bond layer;

FIG. 4A is a cross-sectional illustration of a third exemplary embodiment of a bond layer;

FIG. 4B is a partial cross-sectional perspective illustration of the third exemplary embodiment of the bond layer of FIG. 4A;

FIG. 5 is a partial cross-sectional perspective illustration of an exemplary embodiment of a support flange; and

FIG. 6 is a top view of the outline of a window frame depicting an exemplary window frame configuration.

### DETAILED DESCRIPTION OF EXEMPLARY EMBODIMENTS OF THE INVENTION

Reference will now be made to the drawings to describe exemplary embodiments of the invention. It is to be understood that the drawings are diagrammatic and schematic representations of these embodiments, and are not limiting of the invention, nor are they necessarily drawn to scale.

In general, embodiments of the invention are directed to an improved apparatus and method for bonding of an x-ray tube window to an x-ray tube window frame. Further, embodiments of the invention are directed to a method and apparatus for reducing mechanical and thermal stresses on a window used in an x-ray tube. Moreover, the window is designed to allow x-rays generated within the x-ray tube to exit the x-ray tube without undue attenuation of the x-rays by the window.

### I. Exemplary X-Ray Tube

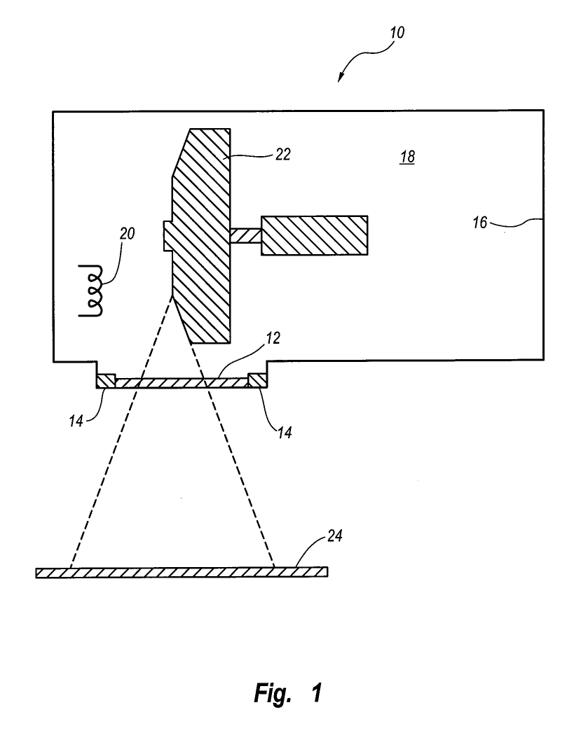

In order to describe the various methods of the invention, attention is directed to FIG. 1 which illustrates a simplified cross-sectional illustration of a typical x-ray tube 10 having a window 12 disposed in a window frame 14 positioned in the side of a housing 16. Housing 16 cooperates with window 12 and window frame 14 to define an evacuated enclosure 18 that encloses a cathode 20 and an anode 22. Window frame 14 is illustrated as being structurally integrated within housing 16. Window 12 separates the vacuum of evacuated enclosure 18 of x-ray tube 10 from the normal atmospheric pressure found outside x-ray tube 10, and yet enables x-rays generated from anode 22 to exit x-ray tube 10 and strike an intended target 24.

Although x-ray tube 10 is depicted as a rotary anode x-ray tube, exemplary embodiments of the invention can be utilized in any type of x-ray tube that utilizes an x-ray transmissive window formed in the housing of the x-ray tube that permits x-rays produced within the x-ray tube to be emitted from the housing.

### II. First Exemplary Bond Layer

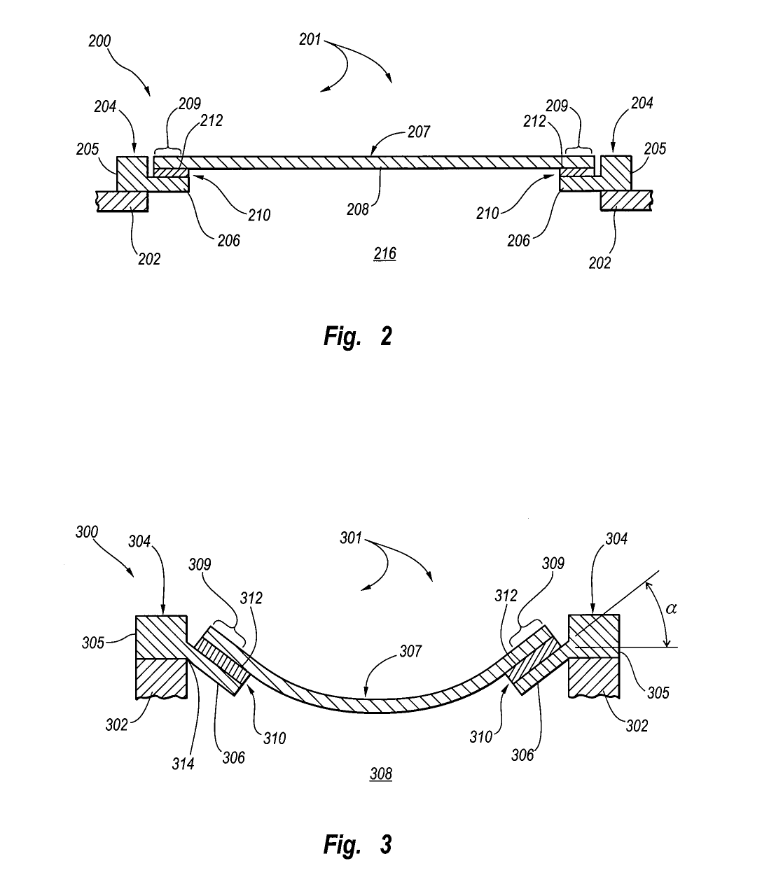

Directing attention now to FIG. 2, details are provided concerning a first exemplary embodiment of a bond layer. An x-ray tube 200 includes a housing 202, as well as a window assembly 201 that includes a window frame 204 that is connected to housing 202. Window frame 204 comprises an outer annular rim 205 and a support flange 206 supporting a window 207 of the window assembly 201. In the exemplary illustrated embodiment, the window 207 of the window assembly 201 can be considered to comprise two portions, particularly, a first portion 208 which does not overlap support flange 206, and a second portion 209 which overlaps support flange 206. Second portion 209 of window 207 is affixed to support flange 206 using a bond layer 210 of the window assembly 201. Specifically, second portion 209 of window 207 is in direct contact with an upper surface 212 of the bond layer 210 of the window assembly 201. The exemplary bond layer 210 of FIG. 2 can be implemented in the x-ray vacuum environment of FIG. 1.

In the illustrated embodiment, outer annular rim 205 of window frame 204 is connected to housing 202. Support flange 206 of window frame 204 is formed along the inside surface of outer annular rim 205, and extends toward the center of the ring formed by window frame 204. The cross-section of window frame 204 is illustrated as generally L-shaped, with support flange 206 extending generally parallel to housing 202 and perpendicular to outer annular rim 205. However, other shapes are possible, including angling support flange 206 upward or downward with respect to housing 202. Exemplary embodiments of support flanges angled downward with respect to a housing are illustrated in FIGS. 3-5 described below.

With continuing reference to FIG. 2, the bond layer 210 is interposed between support flange 206 and window 207. In some embodiments, bond layer 210 is between about 0.001 and about 0.003 inches thick, but the bond layer 210 can be thinner or thicker depending on the particular application. The area of a support flange that is overlapped by a window is defined herein as the bonding area of the support flange, though the bond layer may not, in every case, completely cover the bonding area. Thus, the area of support flange 206 overlapped by window 207 is known as the bonding area of support flange 206. In the exemplary embodiment illustrated in FIG. 2, the bond layer 210 substantially covers the bonding area of support flange 206.

Upper surface 212 of bond layer 210, in contact with second portion 209 of window 207, has a substantially smooth finish. A substantially smooth finish as defined herein includes any surface finish of about 64 microinches or less, which may also be expressed in terms of a surface finish value ‘Ra’ of about 64 or less. One example of a substantially smooth finish is a surface finish of about 32 microinches or less, or a surface finish value Ra of about 32 or less. Another example of a substantially smooth finish is a surface finish of about 8 microinches or less, or a surface finish value Ra of about 8 or less. The substantially smooth finish of upper surface 212 of bond layer 210 can be achieved by cold rolling bond layer 210 after the bond layer 210 is attached to the support flange 206. However, any other method of forming upper surface 212 of bond layer 210 with a surface finish of about 64 microinches or less is contemplated as residing within the scope of the invention.

With continuing reference to FIG. 2, window 207 is diffusion bonded to support flange 206. Several forms of diffusion bonding techniques can be utilized in connection with embodiments of the invention. One exemplary form of diffusion bonding that can be utilized is sometimes referred to as solid-state joining and serves to join two parts together using heat and pressure, but without melting the associated bond layer. This type of solid-state joining process is suitable for joining window 207 to bond layer 210, and for joining bond layer 210 to support flange 206. Diffusion bonding is performed in order to form a vacuum-tight seal between support flange 206 and window 207. This vacuum-tight seal enables a vacuum to be maintained in the interior of the evacuated enclosure 216.

When second portion 209 of window 207 is diffusion bonded to upper surface 212 of bond layer 210, the shape of second portion 209 conforms closely with the shape of upper surface 212. Particularly, the substantially smooth finish of upper surface 212 of bond layer 210 permits window 207 to be diffusion bonded to bond layer 210 and bond layer 210 to be diffusion bonded to support flange 206 with no material deformation of window 207. Thus, the substantially smooth finish of upper surface 212 of bond layer 210 results in an extended operational life of x-ray tube 200 because deformation induced cracking and leaking of window 207, and consequent loss of vacuum from housing 202, is avoided.

### III. Second Exemplary Bond Layer

Directing attention now to FIG. 3, details are provided concerning a second exemplary embodiment of a bond layer. An x-ray tube 300 includes a housing 302 and a window assembly 301 that includes a window frame 304 that is connected to housing 302. Window frame 304 comprises an outer annular rim 305 and a support flange 306 supporting a window 307 of the window assembly 301. In the exemplary illustrated embodiment, the window 307 of the window assembly 301 can be considered to comprise two portions, particularly, a first portion 308 which does not overlap support flange 306, and a second portion 309 which overlaps support flange 306. Second portion 309 of window 307 is affixed to support flange 306 using a bond layer 310 of the window assembly 301. Specifically, second portion 309 of window 307 is in direct contact with an upper surface 312 of the bond layer 310 of the window assembly 301. The exemplary bond layer 310 of FIG. 3 can be implemented in the x-ray vacuum environment of FIG. 1.

In the illustrated embodiment, support flange 306 is formed along the inside surface of outer annular rim 305, and extends toward the center of the ring formed by window frame 304. Further, support flange 306 is oriented at a predetermined angle α at its juncture 314 with outer annular rim 305 such that the support flange 306 is oriented toward the interior of an evacuated enclosure 316, as indicated in FIG. 3. Support flange 306 and bond layer 310 each generally comprise a frustoconical section. In this exemplary embodiment, the window 307, which may be preformed, has a generally bowl-shaped configuration in order to fit snugly within window frame 304. The bowl-shaped configuration of window 307 can be, for example, generally parabolic, elliptical, or spherical. Examples of an angled support flange and a preformed bowl-shaped window are disclosed in U.S. Pat. No. 6,459,768, entitled “X-Ray Tube and Window Frame,” which is incorporated herein by reference.

In the embodiment illustrated in FIG. 3, the bond layer 310 is interposed between support flange 306 and window 307. In some cases, bond layer 310 is similar in thickness to bond layer 210 of FIG. 2, however, any suitable thickness may be employed. Bond layer 310 substantially covers the bonding area of support flange 306. Upper surface 312 of bond layer 310, in contact with second portion 309 of window 307, has a substantially smooth finish, as indicated earlier herein in connection with upper surface 212 of the bond layer 210 disclosed in FIG. 2. Window 307 is diffusion bonded to bond layer 310 and bond layer 310 is diffusion bonded to support flange 306 in order to form a vacuum-tight seal between support flange 306 and window 307. When second portion 309 of window 307 is diffusion bonded to upper surface 312 of bond layer 310, the shape of second portion 309 conforms closely with the shape of upper surface 312. The substantially smooth finish of upper surface 312 of bond layer 310 permits window 307 to be diffusion bonded to bond layer 310 and bond layer 310 to support flange 306 with no material deformation of window 307. Among other things then, the substantially smooth finish of upper surface 312 of bond layer 310 results in an extended operational life of x-ray tube 300 because deformation induced cracking of window 307, and the consequent loss of vacuum from housing 302, is avoided.

### IV. Third Exemplary Bond Layer

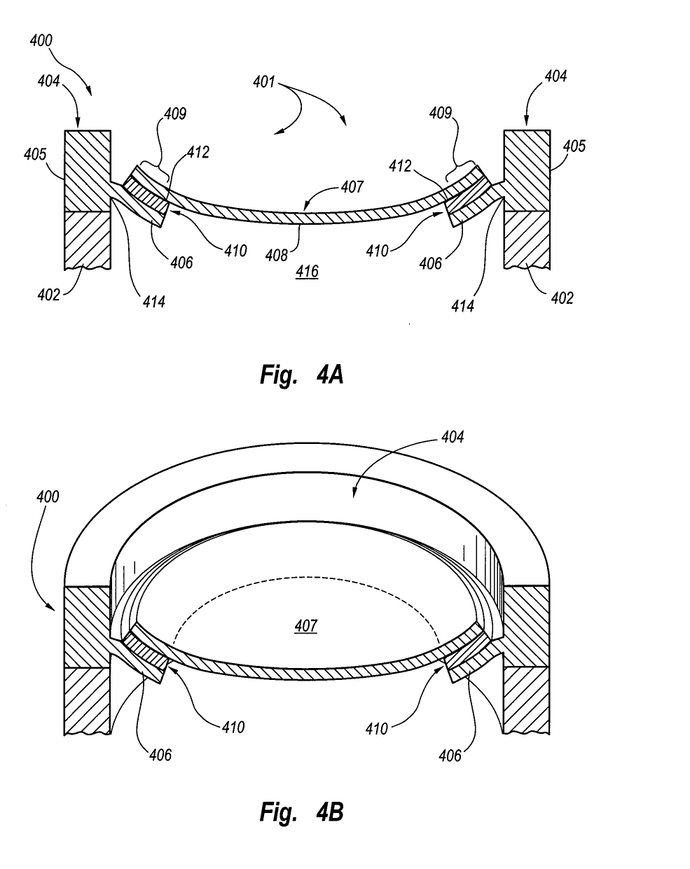

Directing attention now to FIG. 4A, details are provided concerning a third exemplary embodiment of a bond layer. An x-ray tube 400 includes a housing 402 and a window assembly 401 that includes a window frame 404 that is connected to housing 402. Window frame 404 comprises an outer annular rim 405 and a support flange 406 supporting a window 407 of the window assembly 401. In the exemplary illustrated embodiment, window 407 can be considered to comprise two portions, particularly, a first portion 408 which does not overlap support flange 406, and a second portion 409 which overlaps support flange 406. Second portion 409 of window 407 is affixed to support flange 406 using a bond layer 410 of the window assembly 401. Specifically, second portion 409 of window 407 is in direct contact with an upper surface 412 of bond layer 410 of the window assembly 401. The exemplary bond layer 410 of FIG. 4A can be implemented, for example, in the x-ray vacuum environment of FIG. 1.

In the illustrated embodiment, support flange 406 is formed along the inside surface of outer annular rim 405, and extends toward the center of the ring formed by window frame 404. Support flange 406 is oriented at its juncture 414 with rim 405 toward the interior of the evacuated enclosure 416. Further, at least the upper surface of support flange 406 has a generally arcuate cross-section. Additionally, the support flange 406 and bond layer 410 each comprise a frustoconical section. In this exemplary embodiment, the window 407, which may be preformed, has a generally bowl-shaped configuration in order to fit snugly within window frame 404.

In this exemplary embodiment, the bond layer 410 is interposed between support flange 406 and window 407. Bond layer 410 is similar in thickness to bond layer 210 of FIG. 2, but other thicknesses of bond layer 410 may be employed also. Bond layer 410 substantially covers the bonding area of support flange 406. Upper surface 412 of bond layer 410, in contact with second portion 409 of window 407, has a substantially smooth finish, as indicated earlier herein in connection with upper surface 212 of the bond layer 210 disclosed in FIG. 2. Window 407 is diffusion bonded to bond layer 410, and bond layer 410 is diffusion bonded to support flange 406 in order to form a vacuum-tight seal between support flange 406 and window 407. When second portion 409 of window 407 is diffusion bonded to upper surface 412 of bond layer 410, the shape of second portion 409 conforms closely with the shape of Z upper surface 412. The substantially smooth finish of upper surface 412 of bond layer 410 permits window 407 to be diffusion bonded to bond layer 410 and bond layer 410 to be diffusion bonded to support flange 406 with no material deformation of window 407. Thus, the substantially smooth finish of upper surface 412 of bond layer 410 results in an extended operational life of x-ray tube 400 because deformation induced cracking and leaking of window 407, and consequent loss of vacuum from housing 402, is avoided.

Directing attention now to FIG. 4B, further details are provided concerning the exemplary embodiment of bond layer 410 which connects window 407 to window frame 404 of FIG. 4A. Particularly, FIG. 4B illustrates support flange 406 and bond layer 410 as generally defining a frustoconical shape. Similarly, FIG. 4B illustrates support flange 406 having a generally arcuate shape. Also, FIG. 4B illustrates window 407 as generally bowl-shaped.

### V. Exemplary Support Flange

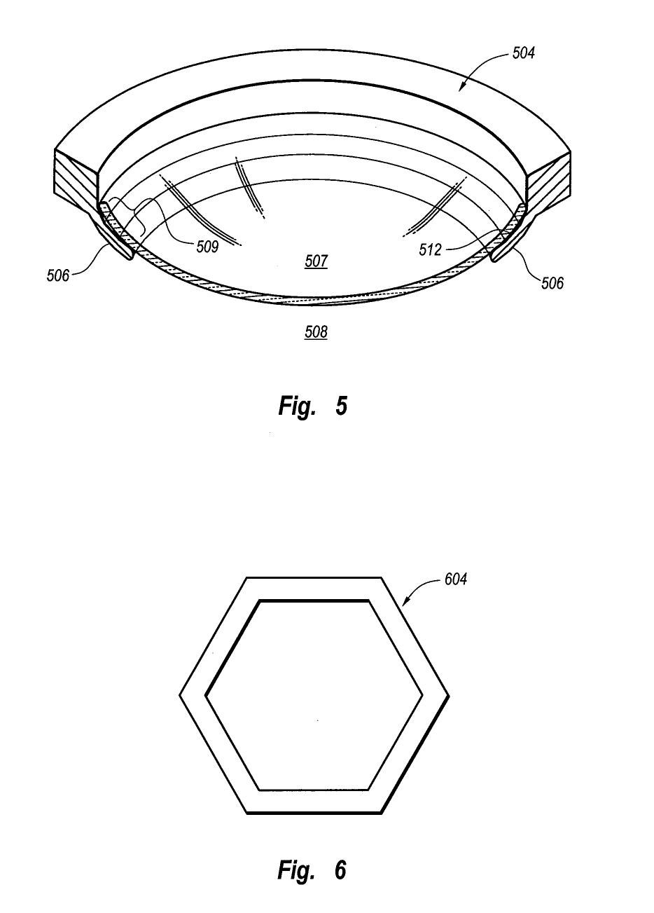

Directing attention now to FIG. 5, details are provided concerning an exemplary window assembly 500 that includes a window frame 504 configured to be connected to an x-ray device housing (not shown). Window frame 504 comprises an outer annular rim 505 and a support flange 506 that supports a window 507 of the window assembly 500. In the exemplary illustrated embodiment, window 507 can be considered to comprise two portions, particularly, a first portion 508 which does not overlap support flange 506, and a second portion 509 which overlaps support flange 506. In contrast with the windows depicted in the exemplary embodiments of FIGS. 2-4B, however, second portion 509 of window 507 in the embodiment disclosed in FIG. 5 is not affixed to support flange 506 using a bond layer, but rather is affixed directly to the surface of support flange 506. Specifically, second portion 509 of window 507 is in direct contact with an upper surface 512 of support flange 506.

In the illustrated embodiment, support flange 506 is formed along the inside surface of c outer annular rim 505, and is oriented and shaped in similar fashion to support flange 406 of FIGS. 4A and 4B. As in the case of other exemplary embodiments disclosed herein, the window 507 may be preformed, and has a generally bowl-shaped configuration in order to fit snugly within window frame 504. Of course, other window shapes and configurations may be employed as well.

Unlike the embodiments disclosed in FIGS. 2-4B, the embodiment disclosed in FIG. 5 does not include a bond layer between support flange 506 and window 507. Instead, the upper surface 512 of support flange 506, in contact with second portion 509 of window 507, has a substantially smooth finish, as described in connection with upper surface 212 of FIG. 2. Window 507 is diffusion bonded to support flange 506 in order to form a vacuum-tight seal between support flange 506 and window 507. When second portion 509 of window 507 is diffusion bonded to upper surface 512 of support flange 506, the shape of second portion 509 conforms closely with the shape of upper surface 512. The substantially smooth finish of upper surface 512 of support flange 506 permits window 507 to be diffusion bonded to support flange 506 with no material deformation of window 507. Thus, the substantially smooth finish of upper surface 512 of support flange 506 results in an extended operational life of x-ray tube 500 because deformation induced cracking and leaking of window 507, and consequent loss of vacuum from housing 502, is avoided.

### VI. Exemplary Window Frame Configuration

FIG. 6 is a top view of the outline of an exemplary window frame 604. It is recognized that the shape of the window frame is not limited to a circle as described in the previous embodiments. Rather, the window frame 604 can be any shape. For example, the window frame of FIG. 6 comprises a hexagonal shape. Accordingly, the shape of the x-ray tube window of the exemplary embodiments depicted in FIG. 2-5 may comprise any shape that is consistent and compatible with the purposes of the device in which the window frame is disposed. Exemplary frame shapes could include, for example, polygonal shapes or elliptical shapes or some combination of the two.

### VII. Other Exemplary Embodiments

It is appreciated that, while the exemplary embodiments illustrated in FIGS. 2-5 utilize a window comprising beryllium, the principles described in these exemplary embodiments can also be applied to windows composed of different materials. For example, x-ray transmissive window materials including titanium, nickel, carbon, silicon, aluminum, biaxially-oriented polyethylene terephthalate, and polyethylene could be employed.

It is also appreciated that, while the support flanges of the exemplary embodiments shown in FIGS. 2-4B illustrate smooth surfaces to which the bond layer is applied, this surface may be roughened to assist in the adhesion of the bond layer thereto. Support flange surfaces have varying degrees of roughness are contemplated as residing within the scope of U exemplary embodiments of the invention illustrated in FIGS. 2-4B.

The support flanges of the window frames shown in FIGS. 2-5 are comprised of stainless steel, nickel-copper alloy, nickel, or any other metals or alloys having suitable characteristics. Also, the outer annular rims of the window frames shown in FIGS. 2-5 are comprised of a metal or metal alloy that can be affixed to the housing of the x-ray tube. However, it should be understood that in some embodiments the window frames shown in FIGS. 2-5 could be integrally formed as part of the housings of the x-ray tubes shown in FIGS. 2-5. Likewise, in some embodiments, the outer annular rims shown in FIGS. 2-5 are omitted.

The bond layers in FIGS. 2-4B are comprised of copper or a copper silver alloy which is soft and has good diffusion characteristics, or any other metal or alloy having suitable characteristics. Likewise, the edges of the bond layers in FIGS. 2-4B that are not in contact with either the support flange or the window can be fillet shaped or curved, instead of generally flat as illustrated in FIGS. 2-4B.

The invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A window assembly for an evacuated housing of an x-ray tube, the window assembly comprising:
a window frame comprising a support flange that defines an aperture;
a window constructed to cover the aperture and overlap an area of the support flange of the window frame; and
a bond layer connecting the window to the area of the support flange overlapped by the window, where a surface of the bond layer in contact with the window has a finish value Ra of about 64 or less, and the bond layer substantially covers the area of the support flange overlapped by the window.

2. The window assembly as recited in claim 1, wherein the window comprises at least one of: beryllium; titanium; nickel; carbon; silicon; aluminum; biaxially-oriented polyethylene terephthalate; or polyethylene.

3. The window assembly as recited in claim 1, wherein the support flange is formed at an angle with respect to the housing.

4. The window assembly as recited in claim 1, wherein the window is generally bowl-shaped.

5. The window assembly as recited in claim 1, wherein the surface of the bond layer in contact with the window has a surface finish value Ra of about 32 or less.

6. The window assembly as recited in claim 1, wherein the surface of the bond layer in contact with the window has a surface finish value Ra of about 8 or less.

7. A method of attaching a window to a support flange of a window frame in an evacuated housing of an x-ray tube, the method comprising:
constructing the window so that it overlaps the support flange of the window frame;
applying a bond layer to a substantial portion of the area of the support flange that is overlapped by the window;
smoothing a surface area of the bond layer to an extent such that subsequent attachment of the window to the smoothed surface area of the bond layer does not result in material deformation of the window;
placing the window on the smoothed surface area of the bond layer; and
diffusion bonding the bond layer to the support flange, and diffusion bonding the window to the bond layer.

8. The method as recited in claim 7, wherein constructing the window comprises shaping the window in a generally circular shape.

9. The method as recited in claim 7, wherein constructing the window comprises shaping the window in a generally bowl shape.

10. The method as recited in claim 7, wherein applying a bond layer comprises cold rolling the bond layer to the support flange overlapped by the window.

11. The method as recited in claim 7, wherein applying a bond layer comprises applying the bond layer such that no portion of the window comes in contact with the support flange.

12. The method as recited in claim 7, wherein smoothing the surface area of the bond layer comprises cold rolling the surface area of the bond layer.

13. A window assembly for an evacuated housing of an x-ray tube, the window assembly comprising:
a window frame comprising a support flange that defines an aperture, a substantially smooth surface area of the support flange having a surface finish value Ra of about 64 or less; and
a window constructed to cover the aperture and overlap the substantially smooth surface area of the support flange, where the portion of the window overlapping the substantially smooth surface area of the support flange is diffusion bonded to the substantially smooth surface area of the support flange, and the diffusion bond forms a vacuum-tight seal between the window and the support flange.

14. The window assembly as recited in claim 13, wherein the window comprises at least one of: beryllium; titanium; nickel; carbon; silicon; aluminum; biaxially-oriented polyethylene terephthalate; or polyethylene.

15. The window assembly as recited in claim 13, wherein the support flange is formed at an angle with respect to the housing.

16. The window assembly as recited in claim 13, wherein the window is generally bowl-shaped.

17. The window assembly as recited in claim 13, wherein the smooth surface area surface area of the support flange has a surface finish value Ra of about 32 or less.

18. The window assembly as recited in claim 13, wherein the smooth surface area of the support flange has a surface finish value Ra of about 8 or less.
